(19) United States
(12) Patent Application Publication
(10) Pub. No.: US 2024/0184003 A1
(43) Pub. Date: Jun. 6, 2024

(54) DISTRIBUTED SENSING USING FLUID NETWORK

(71) Applicant: X Development LLC, Mountain View, CA (US)

(72) Inventors: Alex S. Miller, Cambridge, MA (US); Artem Goncharuk, Mountain View, CA (US); Kevin Forsythe Smith, Pleasanton, CA (US)

(21) Appl. No.: 18/528,036

(22) Filed: Dec. 4, 2023

Related U.S. Application Data
(60) Provisional application No. 63/429,632, filed on Dec. 2, 2022.

(51) Int. Cl. G01V 1/133; G01V 1/22; G01V 1/30

(52) U.S. Cl. CPC G01V 1/133; G01V 1/226; G01V 1/301; G01V 2210/1299

(57) ABSTRACT

This disclosure describes a system and method for generating subsurface image data by inducing a first acoustic energy in a fluid contained within a pipe network at a predetermined location. The acoustic energy propagates through the pipe network and into a subsurface in which the pipe network is contained and is then recorded using an array of transducers. The recorded acoustic energy is provided as input to a machine learning algorithm to generate image data associated with the subsurface, which is used to generate a subsurface model for presentation in a graphical user interface.

### CROSS-REFERENCE TO RELATED APPLICATION

This application claims priority under 35 U.S.C. § 119 to U.S. Provisional Patent Application Ser. No. 63/429,632, filed on Dec. 2, 2022, the entire contents of which are incorporated by reference herein.

### TECHNICAL FIELD

This disclosure generally relates to generating subsurface images using a fluid network as a transmission medium.

### BACKGROUND

Urban and suburban areas often include dense pipe and fluid networks including gas lines, sewage lines, potable water lines and others. This pre-existing infrastructure is often positioned below ground, in the subsurface.

### SUMMARY

In general, the disclosure involves a system, computer readable medium, and a method for generating subsurface imaging data. These include inducing a first acoustic energy in a fluid contained within a pipe network at a predetermined location. Recording second acoustic energy that propagates in response to the induced first acoustic energy from the fluid through the pipe network and into a subsurface. The recording can be done using an array of transducers. Providing the recorded, acoustic energy as input to a machine earning algorithm in order to generate image data associated with the subsurface. Generating a subsurface model that includes the generated image data for presentation in a graphical user interface using the machine learning algorithm.

Implementations can optionally include one or more of the following features.

In some implementations, a pipe network pressure and fluid temperature are sensed at the predetermined location and the pipe network pressure and fluid temperature are provided to the machine learning algorithm as input.

In some implementations, the predetermined location is identified based on a GPS signal.

In some implementations, the predetermined location is one of a plurality of predetermined locations, and a time is selected for each predetermined location to cause constructive interference in the first acoustic energy from each of the plurality of predetermined locations at a target location. The induced first acoustic energy can be induced at each of the plurality of predetermined locations at the predetermined time.

In some implementations distributed acoustic sensing is performed in one or more fiber optic cables to obtain strain data associated with the cables, where the cables are in a region that includes the pipe network. The strain data can be provided as an input to the machine learning algorithm.

In some implementations, the one or more fiber optic cables are adjacent to one or more pipes of the pipe network.

In some implementations, the first acoustic energy is induced by a transducer of a meter configured to measure flow in the pipe network. In some implementations, the meter includes a GPS receiver, a pressure sensor, and a temperature sensor. In some implementations, the meter is configured to both induce the first acoustic energy, and record the second acoustic energy.

Implementations can include one or more of the following advantages. The disclosed solution can use preexisting infrastructure, requiring minimal additional hardware installation (e.g., just modernized meters) in order to create a large scale, high resolution subsurface sensing array. Additionally, high time resolution, long term sensing can be conducted with the disclosed methods, since they do not require burial and subsequent retrieval of sensor within the subsurface.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

In general, this disclosure relates to generating subsurface images using a fluid network as an acoustic medium.

FIG. 1 depicts an example implementation of a system for generating subsurface images.

FIG. 2 depicts a block diagram of an example implementation of an analyzing system for generating subsurface image data.

FIG. 3 is a flowchart describing an example method for generating subsurface image data.

FIG. 4 depicts a computing system for generating subsurface image data.

### DETAILED DESCRIPTION

This disclosure describes a system and method for generating subsurface imaging data using fluid networks. Urban and suburban regions typically have relatively dense pipe networks carrying fluids. For example, water supply networks, sewage lines, natural gas networks, district cooling fluids, and other pipe networks that carry supply fluids to or remove fluids from residential areas, businesses, utilities, and other structures. Many of these structures or endpoints in the various pipe networks include meters that measure fluid flow at the endpoint (e.g., water meter, gas meter, etc.). These meters can be equipped with additional sensors and one or more transducers that are capable of transmitting acoustic energy into the fluid. By coordinating multiple transducers at multiple known locations within a known pipe network, inferences about the subsurface in which the pipe network is located can be determined.

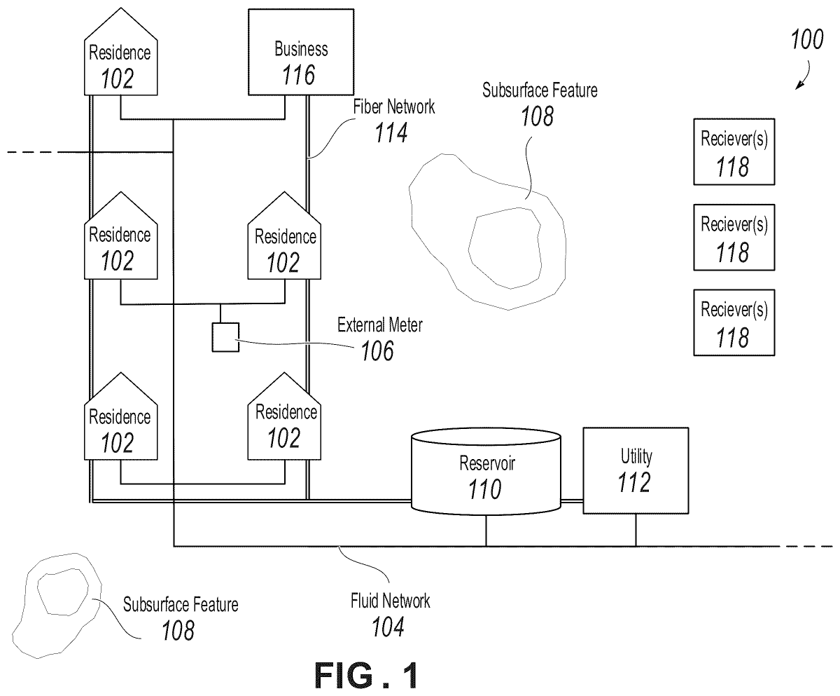

FIG. 1 depicts a system 100 for generating subsurface images. System 100 includes multiple residences 102 connected using a fluid network 104. One or more external meters 106 can also be connected to the fluid network 104, as well as a reservoir 110 and one or more utilities 112 and one or more businesses 116.

Each residence 102, and business 116, can have a local meter installed, which measures fluid consumption or production. In some implementations, a gas meter, water meter, or other device is installed. For example, where the fluid network 104 is a water plumbing network, each residence 102 can include a water meter that records water consumed. The meters can also include additional sensors, such as a GPS receiver to provide timing and location information, pressure sensors, temperature sensors, as well as communications equipment (e.g., WIFI, Bluetooth, Ethernet, coaxial cable, etc.). Each meter can further include one or more transducers which can transmit or receive acoustic energy from the fluid within the fluid network 104. The meters at each residence 102 (and business 116) as well as other facilities in system 100 (e.g., reservoir 110, utility 112 etc.) can operate in coordination as an array.

External meter(s) 106 can further be present in the system, and can be installed, for example, at a fire hydrant, temporarily or permanently, and can provide additional sensing/transmission points.

The utility 112 can manage supply or removal of fluid from the fluid network 104. In some instances, the utility 112 manages one or more meters associated with the residences 102 and business(s) 116. The utility 112 can manage one or more reservoirs 110 which store excess fluid and can be used to maintain a specified pressure level within the fluid network 104.

In addition to a fluid network, a fiber network 114 can be installed in the same region. In some implementations, fiber network 114 is a communications network (e.g., internet, or telephone). In some implementations, fiber network 114 is a dedicated sensing network, such as a distributed acoustic sensing (DAS) network installed to monitor the condition of fluid network 104 or other features. In some implementations, where the fiber network 114 is a communications network, additional interrogators can be installed (e.g., at utility 112) in order to allow the fiber network 114 to temporarily, or periodically operate as a DAS sensor.

A receiver array, or one or more receiver(s) 118 can be available and can record sound transmitted by the meters, through the fluid network, into the subsurface, and reflecting off or passing through one or more subsurface features 108. Receivers 118 can be, but are not limited to, seismometers, accelerometers, vibrometers, or a combination thereof. In some implementations, the receiver array 118 is integral to the meters or transmitter array in the fluid network 104. In some implementations, the receiver array 118 is a separate array.

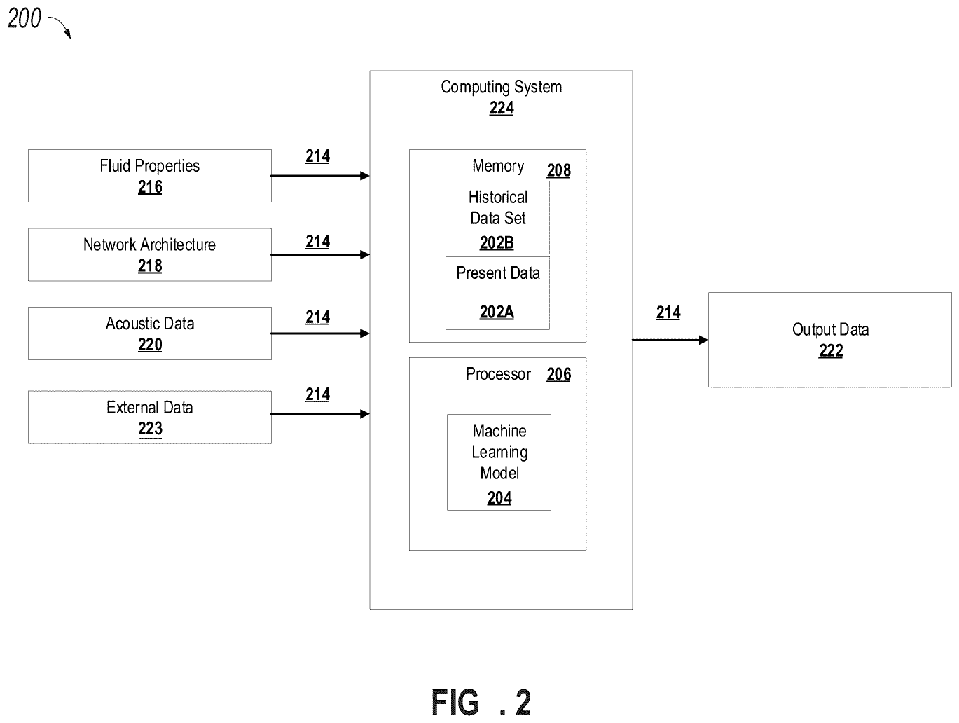

FIG. 2 is a block diagram of an example analyzing system 200 for generating subsurface imaging data. The computing system 224 can receive data from various systems (e.g., the meters at residence(s) 102 and business(s) 106, receiver array 118, of FIG. 1) via a communications link 214. In some implementations, computing system 224 receives information from other external systems or services (e.g., weather data, or survey data from third party sources). The communication interface 214 can be but is not limited to a wired communication interface (e.g., USB, Ethernet, fiber optic) or wireless communication interface (e.g., Bluetooth, ZigBee, WiFi, infrared (IR), CDMA2000, etc.). The communication interface 214 can be used to communicate directly or indirectly, e.g., through a network, with the computing system 224.

The computing system 224 receives present data 202A from various sources via the communications link 214. Present data 202A can be data included in the most recent readings taken from a receiver array. Present data 202A can include, but is not limited to fluid property data 216, network architecture data 218, and acoustic data 220, each which can be data recorded by one or more receivers (e.g., receiver array 118 of FIG. 1), external data 223, which can be recorded by an additional source, such as a DAS network, or other subsurface imaging device being used in conjunction with the systems described herein. In some implementations, the present data 202A can be received in real-time. For example, the total delay between sensed and received data can be less than 1 millisecond (ms) or less than 1 second (s), or can be without intentional delay taking into account processing limitations of the system.

The present data 202A is then used by the machine learning model 204 operating with a processor 206 to generate a quantified output.

Fluid properties 216 can be properties of the fluid being used as a transmission/reception medium in the fluid network and can either be sensed (e.g., temperature, pressure, salinity, etc.) or calculated parameters based on other measurements (e.g., viscosity, conductivity, density, specific gravity, etc.). In some implementations, the fluid properties 216 are based on the fluid type (e.g., water, natural gas, oil, etc.) and account for known properties of the fluid type. In some implementations, the fluid properties 216 further include fluid measurements such as temperature, pressure, salinity, flow-rate, viscosity, or other parameters. Additional fluid properties 216 can be determined based on fluid measurements. For example, a sound speed of acoustic wave transmission velocity can be determined for a given fluid at a measured temperature, pressure, and salinity. In some implementations, instead of salinity, ionic concentration, particulate concentration, or other factors are considered.

Network architecture data 218 can include data recorded from one or more surveys, or installation related data from the time of installation of the fluid or infrastructure network. In some implementations network architecture 218 includes location, depth, diameter, and construction material for the fluid piping of the fluid network. Network architecture data 218 can further include joint or junction locations, typical usage profiles, or other information. In some implementations, network architecture data 218 is provided by a utility (e.g., utility 112 of FIG. 1) or other third party, and is static (e.g., relatively slow changing) data that provides a baseline of the geometry for the fluid network (or fiber network) being used. In some implementations, the network architecture data 218 can be created by the system. For example, system 100 can “map” the fluid network by inducing transients (e.g., acoustic, or optical) at a known time and recording the received response across various sensors (e.g., using meters at residence s 102, external meters 106 or others). In some implementations, the system 100 can perform time domain reflectometry within the fluid network in order to develop network architecture data 218.

Acoustic data 220 can be data received by one or more receivers (e.g., receiver array 118 of FIG. 1) or by meters or transmitters within a fluid network (e.g., fluid network 104) and can represent energy that has been reflected or transmitted from a fluid network, through a subsurface region. Acoustic data 220 can be generated by an array of transducers within a fluid network (e.g., each one of many residential meters with transducers installed). If the location of each source in the fluid network is known, and a general network architecture is available (e.g., network architecture data 218), then the array of transducers can act as a phased array, transmitting signals with individual delays in order to concentrate acoustic energy at a particular location within the fluid network. For example, a distance between the particular location and each transducer can be calculated or otherwise identified, and then a corresponding time delay can be introduced in the signal to be transmitted by the transducer, in order to maximize constructive interference of the acoustic signal at the particular location from each transducer in the array of transducers. In this manner, the acoustic data 220 can represent a “virtual” or artificial source at a location within the fluid network which was generated via an array of transducers acting as a phased array.

External data 223 can augment the other data and can include ambient data, alternative sensor data, static data, or others. For example, external data 223 can include ambient data such as weather, surface temperature, subsurface temperature, precipitation, barometric pressure, system pressure (e.g., fluid system 104 of FIG. 1), traffic density, or other parameters. Alternative sensor data can include data from a DAS sensor (e.g., using fiber network 114 of FIG. 1) or other seismologic sensors such as seismometers, accelerometers, ground penetrating radar imaging, etc. Static data can include information regarding the region being sensed or areas of interest that do not routinely change. Static data can include, but is not limited to, construction data, geologic characteristics, prior survey data, or location information.

The computing system 224 can store in memory 208 a historical data set 202B. The historical data set can include all data that has previously been used in a particular region, or a subset of the previous data. The historical data set 202B can also include data relating to common trends seen across multiple regions or locations, or trends seen among particular locations or regions or any suitable combination thereof.

The machine learning model 204 receives the present data 202A, and the historical data 202B and generates a quantified output. For example, the machine learning model 204 can analyze the acoustic data 220 the external data 223, network architecture 218 and fluid properties 216 to generate subsurface measurements for the region and provide them as output data 222. Output data 222 can represent a high resolution image of a subsurface object, or a high time resolution measurement of subsidence, or other slow scale events. In some implementations, the output data 222 can include location, form, material, and contents of a subsurface region.

In some implementations, the machine learning model 204 is a deep learning model that employs multiple layers of models to generate an output for a received input. A deep neural network is a deep machine learning model that includes an output layer and one or more hidden layers that each apply a non-linear transformation to a received input to generate an output. In some cases, the neural network may be a recurrent neural network. A recurrent neural network is a neural network that receives an input sequence and generates an output sequence from the input sequence. In particular, a recurrent neural network uses some or all of the internal state of the network after processing a previous input in the input sequence to generate an output from the current input in the input sequence. In some other implementations, the machine learning model 204 is a convolutional neural network. In some implementations, the machine learning model 204 is an ensemble of models that may include all or a subset of the architectures described above. In some implementations, the machine learning model 204 is a graph neural network (GNN). GNNs are a designed to process data that can be represented in a graph form and feature pairwise message passing to enable iterative updating of node representation of the graph data.

In some implementations, the machine learning model 204 can be a feedforward auto-encoder neural network. For example, the machine learning model 204 can be a three-layer auto-encoder neural network. The machine learning model 204 may include an input layer, a hidden layer, and an output layer. In some implementations, the neural network has no recurrent connections between layers. Each layer of the neural network may be fully connected to the next, e.g., there may be no pruning between the layers. The neural network may include an optimizer for training the network and computing updated layer weights, such as, but not limited to, ADAM, Adagrad, Adadelta, RMSprop, Stochastic Gradient Descent (SGD), or SGD with momentum. In some implementations, the neural network may apply a mathematical transformation, e.g., a convolutional transformation or factor analysis to input data prior to feeding the input data to the network.

In some implementations, the machine learning model 204 can be a supervised model. For example, for each input provided to the model during training, the machine learning model 204 can be instructed as to what the correct output should be. The machine learning model 204 can use batch training, e.g., training on a subset of examples before each adjustment, instead of the entire available set of examples. This may improve the efficiency of training the model and may improve the generalizability of the model. The machine learning model 204 may use folded cross-validation. For example, some fraction (the “fold”) of the data available for training can be left out of training and used in a later testing phase to confirm how well the model generalizes. In some implementations, the machine learning model 204 may be an unsupervised model. For example, the model may adjust itself based on mathematical distances between examples rather than based on feedback on its performance.

The machine learning model 204 can be, for example, a deep-learning neural network or a “very” deep learning neural network. For example, the machine learning model 204 can be a convolutional neural network. The machine learning model 204 can be a recurrent network. The machine learning model 204 can have residual connections or dense connections. The machine learning model 204 can be an ensemble of all or a subset of these architectures. The model may be trained in a supervised or unsupervised manner. In some examples, the model may be trained in an adversarial manner. In some examples, the model may be trained using multiple objectives, loss functions or tasks.

In some implementations, the machine learning model 204 can generate output data 222 based on recorded data only. In other words, the output data 222 can be a new result, based on no prior collections. In some implementations, the machine learning model 204 can use acoustic data 220 and network architecture data 218 to improve a previously existing subsurface image, such as might be present in external data 223.

In some implementations, the machine learning model 204 can provide suggested additional data that could further improve the output of the machine learning model 204. For example, the machine learning model 204 could provide suggested frequencies for a source acoustic signal to maximize the quality of acoustic data 220. In another example, the machine learning model 204 could provide recommended locations for receivers (e.g., receivers 118 of FIG. 1) to record acoustic data 220.

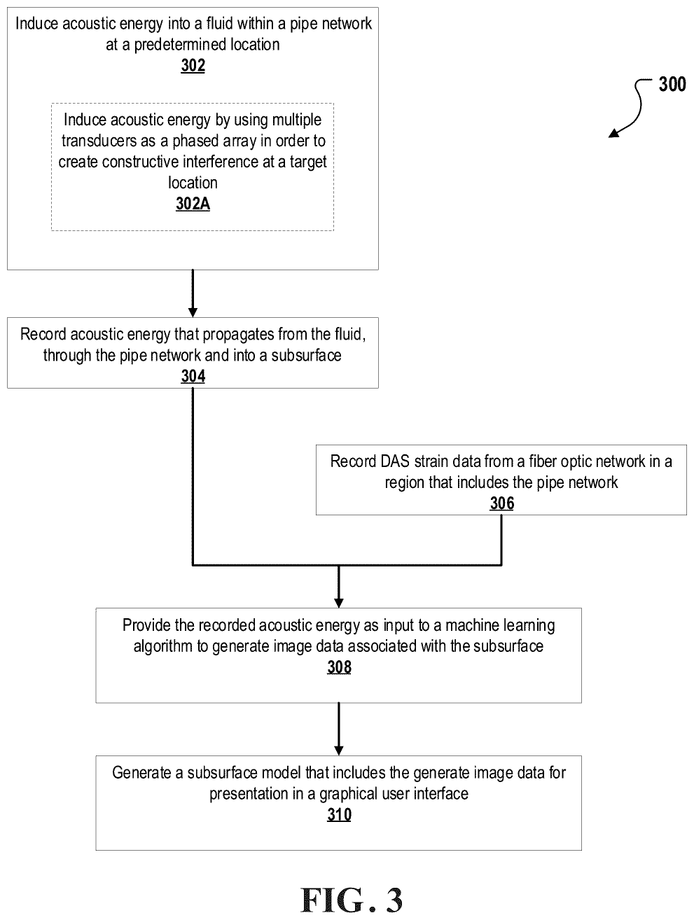

FIG. 3 is a flowchart describing an example method for generating a subsurface image. In some implementations, the example process 300 may be performed using one or more computer-executable programs executed using one or more computing devices.

At 302, acoustic energy is induced into a fluid within a pipe network at a predetermined location. The predetermined location can be identified based on a GPS signal received at a receiver mounted on one or more transducers used to induce the acoustic energy. In some implementations, the acoustic energy is induced using transducers installed on residential or business meters that otherwise measure fluid flow, pressure, or other parameters associated with a pipe network. In some instances, multiple transducers can be used in coordination as a phased array (302A) in order to concentrate acoustic energy in a particular location or target location within the pipe network.

At 304, after the induced acoustic energy propagates through the fluid and into the subsurface within which the pipe network is installed, it can be recorded by one or more receivers. The recorded acoustic energy can be pre-processed. For example, it can be analyzed for time delay or “time of flight” from transmission, as well as frequency shift, phase shift, or other parameters. The acoustic energy data, and the pre-processed data can be recorded for future processing. In some implementations the induced acoustic data is recorded using the same transducers that transmitted it. In some implementations, a separate receiver or receiver array is provided for recording the acoustic data.

At 306, in addition to the acoustic data, strain data of a fiber optic network can be recorded using distributed acoustic sensing (DAS). Fiber optic cables are generally designed to transmit optical signals. Fiber optic cables reflect or scatter optic energy in the cable and interferometric device (e.g., and interrogator) can generate one or more standing waves of optic energy in the fiber optic cable in order to measure interference in the standing wave to sense changes in density in the fiber optic cable and measure these changes as a function of strain present in the cable. In some implementations, the interferometric device can perform interferometric measurements on live cables, that is, cables that are actively transmitting data. In some implementations, the interferometric device performs interferometric measurements on dark cables, or cables that are not transmitting data.

The interferometric device can generate information that represents a time varying strain function for the length of the fiber optic cable. Seismic energy or acoustic energy present in the subsurface can cause perturbations or changes in the strain in the fiber optic cable, thus DAS can be used to detect and track subsurface seismic or acoustic energy as it interacts with subsurface fiber optic cables.

At 308, the acoustic energy data is provided to a machine learning algorithm in order to generate image data associated with the subsurface. Optionally, the DAS strain data generated at 306 is provided as additional input, to be analyzed in addition to, or in conjunction with the acoustic energy. The machine learning algorithm can generate a high resolution image of a subsurface object, or a high time resolution measurement of subsidence, or other slow scale events. In some implementations, the generated output is data indicative of a change in the fluid network, or a change in the subsurface containing the fluid network. In some implementations, the output data is a waterfall plot representing seismic activity over time in a single dimension. In some implementations, the output is a 2D, time varying map illustrating pipe deformation, strain data, or energy dissipation.

At 310, a subsurface model is generated based on the generated image data for presentation in a graphical user interface. The subsurface model includes the generated imaging data, and can represent an amalgam of data regarding a region of the subsurface, which includes information from detected acoustic energy passing through the pipe network into the subsurface, as well as DAS data from one or more fiber optic cables, among other data.

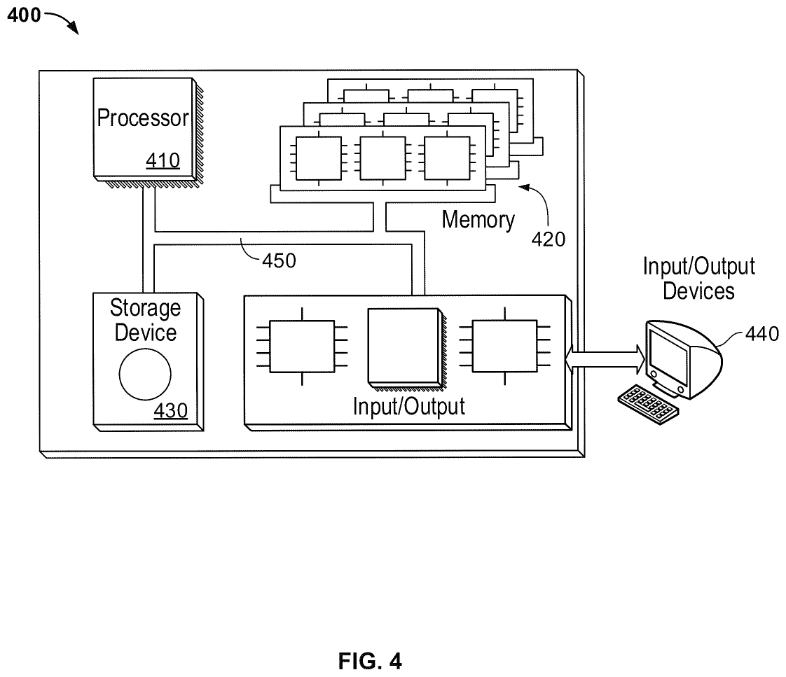

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., computing system 224) and their structural equivalents, or in combinations of one or more of them. The system 400 is intended to include various forms of digital computers, such as laptops, desktops, workstations, servers, blade servers, mainframes, and other appropriate computers. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The machine learning model can run on Graphic Processing Units (GPUs) or custom machine learning inference accelerator hardware.

To provide for interaction with a user, the features can be implemented on a computer having a display device such as a CRT (cathode ray tube) or LCD (liquid crystal display) monitor for displaying information to the user and a keyboard and a pointing device, such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

What is claimed is:

1. A method for generating subsurface image data, the method comprising:
inducing first acoustic energy in a fluid contained within a pipe network at a predetermined location;
recording, using an array of transducers, second acoustic energy that propagates, in response to the induced first acoustic energy, from the fluid through the pipe network and into a subsurface;
providing the recorded, acoustic energy as an input to a machine learning algorithm to generate image data associated with the subsurface; and
generating, with the machine learning algorithm, a subsurface model that comprises the generated image data for presentation in a graphical user interface.

2. The method of claim 1, comprising:
sensing a pipe network pressure and fluid temperature at the predetermined location; and
providing the sensed pipe network pressure and fluid temperature to the machine learning algorithm as input.

3. The method of claim 1, wherein the predetermined location is identified based on a GPS signal.

4. The method of claim 1, wherein the predetermined location is one of a plurality of predetermined locations, the method comprising:
selecting a predetermined time for each of the plurality of predetermined locations to cause constructive interference in the first acoustic energy from each of the plurality of predetermined locations at a target location; and
inducing the first acoustic energy in the fluid at each of a plurality of predetermined locations, each induction occurring at a predetermined time.

5. The method of claim 1, comprising:
performing distributed acoustic sensing (DAS) in one or more fiber optic cables to obtain strain data associated with the cables, wherein the fiber optic cables are in a region comprising the pipe network; and
providing the strain data to the machine learning algorithm as input.

6. The method of claim 5, wherein the one or more fiber optic cables are adjacent to one or more pipes of the pipe network.

7. The method of claim 1, wherein the first acoustic energy is induced by a transducer of a meter configured to measure flow in the pipe network.

8. The method of claim 7, wherein the meter comprises a GPS receiver, a pressure sensor, and a temperature sensor.

9. The method of claim 7, wherein the meter is configured to both induce the first acoustic energy and record the second acoustic energy.

10. A non-transitory, computer readable storage medium storing instructions that, when executed by at least one processor, cause the at least one processor to perform operations comprising:
inducing first acoustic energy in a fluid contained within a pipe network at a predetermined location;
recording, using an array of transducers, second acoustic energy that propagates, in response to the induced first acoustic energy, from the fluid through the pipe network and into a subsurface;
providing the recorded, acoustic energy as an input to a machine learning algorithm to generate image data associated with the subsurface; and
generating, with the machine learning algorithm, a subsurface model that comprises the generated image data for presentation in a graphical user interface.

11. The non-transitory, computer readable medium of claim 10, the operations comprising:
sensing a pipe network pressure and fluid temperature at the predetermined location; and
providing the sensed pipe network pressure and fluid temperature to the machine learning algorithm as input.

12. The non-transitory, computer readable medium of claim 10, wherein the predetermined location is identified based on a GPS signal.

13. The non-transitory, computer readable medium of claim 10, wherein the predetermined location is one of a plurality of predetermined locations, the operations comprising:
selecting a predetermined time for each of the plurality of predetermined locations to cause constructive interference in the first acoustic energy from each of the plurality of predetermined locations at a target location; and
inducing the first acoustic energy in the fluid at each of a plurality of predetermined locations, each induction occurring at a predetermined time.

14. The non-transitory, computer readable medium of claim 10, the operations comprising:
performing distributed acoustic sensing (DAS) in one or more fiber optic cables to obtain strain data associated with the cables, wherein the fiber optic cables are in a region comprising the pipe network; and
providing the strain data to the machine learning algorithm as input.

15. The non-transitory, computer readable medium of claim 14, wherein the one or more fiber optic cables are adjacent to one or more pipes of the pipe network.

16. The non-transitory, computer readable medium of claim 10, wherein the first acoustic energy is induced by a transducer of a meter configured to measure flow in the pipe network.

17. The non-transitory, computer readable medium of claim 16, wherein the meter comprises a GPS receiver, a pressure sensor, and a temperature sensor.

18. The non-transitory, computer readable medium of claim 16, wherein the meter is configured to both induce the first acoustic energy and record the second acoustic energy.

19. A system for generating a subsurface image comprising:
one or more processors;
one or more tangible, non-transitory media operably connectable to the one or processors and storing a machine learning model that, when executed, cause the one or more processors to perform operations comprising:
causing at least one acoustic source to induce first acoustic energy in a fluid contained within a pipe network at a predetermined location;
recording, using an array of transducers, second acoustic energy that propagates, in response to the induced first acoustic energy, from the fluid through the pipe network and into a subsurface;
providing the recorded, acoustic energy as an input to a machine learning algorithm to generate image data associated with the subsurface; and
generating, with the machine learning algorithm, a subsurface model that comprises the generated image data for presentation in a graphical user interface.

20. The system of claim 19, the operations comprising:
sensing a pipe network pressure and fluid temperature at the predetermined location; and
providing the sensed pipe network pressure and fluid temperature to the machine learning algorithm as input.

21. The system of claim 19, wherein the predetermined location is identified based on a GPS signal.

22. The system of claim 19, wherein the predetermined location is one of a plurality of predetermined locations, the operations comprising:
selecting a predetermined time for each of the plurality of predetermined locations to cause constructive interference in the first acoustic energy from each of the plurality of predetermined locations at a target location; and
inducing the first acoustic energy in the fluid at each of a plurality of predetermined locations, each induction occurring at a predetermined time.

23. The system of claim 19, the operations comprising:
performing distributed acoustic sensing (DAS) in one or more fiber optic cables to obtain strain data associated with the cables, wherein the fiber optic cables are in a region comprising the pipe network; and
providing the strain data to the machine learning algorithm as input.

24. The system of claim 23, wherein the one or more fiber optic cables are adjacent to one or more pipes of the pipe network.

25. The system of claim 19, wherein the at least one acoustic source comprises at least one meter configured to measure flow in the pipe network.

26. The system of claim 25, wherein the meter comprises a GPS receiver, a pressure sensor, and a temperature sensor.

27. The system of claim 25, wherein the meter is configured to both induce the first acoustic energy and record the second acoustic energy.
